(19) United States
(12) Patent Application Publication
(10) Pub. No.: US 2014/0272903 A1
(43) Pub. Date: Sep. 18, 2014

(54) SYSTEM FOR IDENTIFYING ORIENTATIONS OF AN INDIVIDUAL

(71) Applicants: Robert Bernard Rosenfeld, Rochester, NY (US); Laurence A. Van Etten, Rochester, NY (US)

(72) Inventors: Robert Bernard Rosenfeld, Rochester, NY (US); Laurence A. Van Etten, Rochester, NY (US)

(21) Appl. No.: 13/834,890

(22) Filed: Mar. 15, 2013

(51) Int. Cl. G09B 7/06

(52) U.S. Cl. CPC G09B 7/06
USPC 434/362

(57) ABSTRACT

A system for identifying preferences of a user and demonstrating the preferences in a graphical manner, the system comprising an input apparatus to facilitate recording of answers to a plurality of groups of questions from the user, a processing apparatus to facilitate calculation of output parameters, each of the output parameters is calculated by averaging answers to each of the plurality of groups of questions and a graphical apparatus to display the output parameters of each of the user in a graphical format, wherein each of the output parameters is depicted as its affinity to two diverse poles.

### BACKGROUND OF THE INVENTION

1. The Field of the Invention

The present invention is directed generally to a system for identifying orientations or preferences of an individual. More specifically, the present invention is directed to a system for identifying orientations of an individual in which all three aspects of mental functioning, i.e., cognitive, conative and affective are considered.

2. Background Art

There have been numerous tools devised for aiding organizations in finding the most suitable individuals to fill positions in a team environment or to perform tasks individually. One such tool is the Myers-Briggs type indicator (MBTI) developed based on Carl Jung's theories. The MBTI tool resolves one's behavior into 16 personality types.

As having the right individuals assigned to a project can directly affect the success of the project, businesses have looked to tools which aid them in detecting the traits which make individuals suitable for the project. Such tools are typically not available through technical-oriented tests or resumes. These existing tools all lack the ability to identify and integrate an individual's cognitive, conative and affective orientation, which when combined with the individual's level of technical skills and values, can be a valuable indicator for selecting individuals that perform well. In addition, the resources spent in an interview or vetting process must not be overlooked. Typically, the fewer steps involved, the speedier, more focused and hence less costly it is.

U.S. Pat. No. 8,317,520 to Swanson (hereinafter Swanson) discloses a system, method and apparatus configured to measure and classify innovation skills and technical capability of individuals based on predefined referencable attributes. The classification is used to help individuals to improve their innovative abilities and to build innovation teams. The classifications are stored such that they may be further analyzed and used. In Swanson, an instrument for testing the technical capability of individuals is an integral portion. Swanson fails to uncover preferences that can be used to identify suitable individuals for specific positions both as an individual functioning alone or in a team environment.

Thus, there arises a need for a system for identifying the orientations of an individual that is simple to conduct and whose result is simple to interpret.

### SUMMARY OF THE INVENTION

The present invention is directed toward a computer system for identifying preferences of a user and demonstrating the preferences in a graphical manner, the computer system comprising:
(a) a processor, the processor being a hardware component of the computer system; and
(b) a memory device in communication with the processor, the memory device storing a plurality of instructions that when executed by the processor, execute the steps of:
   (i) providing an interface application, displayed on an electronic device, the interface having selectable options including at least an option to access data comprising a plurality of groups of questions, wherein each of the plurality of groups of questions comprises at least two questions whose answer choices are expressed as their affinity to two diverse poles;
   (ii) in response to a user selection, via an electronic input device, to access the plurality of groups of questions, searching a question database, where the question database stores a plurality of groups of questions, wherein at least two questions of each of the plurality of groups of questions are presented in a non-consecutive manner to at least one other question of the plurality of groups of questions;
   (iii) accepting an answer to each question of the plurality of groups of questions and recording the answer;
   (iv) calculating output parameters that identify preferences of the user, where each of the output parameters is calculated by averaging answers to each question in each group of questions, wherein the output parameters comprise the user's ideation, risk, process, the sum of the user's ideation, risk and process, control, relationship, networking, input, flow, passion, output and energy; and
   (v) displaying the output parameters in a graphical format on an electronic device, wherein each of the output parameters is depicted as its affinity to the two diverse poles.

The present invention is also directed toward a computer system for identifying preferences of a user and demonstrating the preferences in a graphical manner, the computer system comprising:
(a) a processor, the processor being a hardware component of the computer system;
(b) a logic element in communication with the processor, configured to cause the processor to execute the steps of:
   (i) providing an interface application, displayed on an electronic device, the interface having selectable options including at least an option to access data comprising a plurality of groups of questions, wherein each of the plurality of groups of questions comprises at least two questions whose answer choices are expressed as their affinity to two diverse poles;
   (ii) in response to a user selection, via an electronic input device, to access the plurality of groups of questions, searching a question database, where the question database stores a plurality of groups of questions, wherein at least two questions of each of the plurality of groups of questions are presented in a non-consecutive manner to at least one other question of the plurality of groups of questions;
   (iii) accepting an answer to each question of the plurality of groups of questions and recording the answer;
   (iv) calculating output parameters that identify preferences of the user, where each of the output parameters is calculated by averaging the answers to each question in each group of questions, wherein the output parameters comprise the user's ideation, risk, process, the sum of the user's ideation, risk and process, control, relationship, networking, input, flow, passion, output and energy; and
   (v) displaying the output parameters in a graphical format on an electronic device, wherein each of the output parameters is depicted as its affinity to the two diverse poles.

The present invention is also directed toward a computer readable medium with program instructions tangibly stored thereon for identifying preferences of a user and demonstrating the preferences in a graphical manner, the program instructions comprising instructions for:
(a) providing an interface application, displayed on an electronic device, the interface having selectable options including at least an option to access data comprising a plurality of groups of questions, wherein each of the plurality of groups of questions comprises at least two questions whose answer choices are expressed as their affinity to two diverse poles;
(b) in response to a user selection, via an electronic input device, to access the plurality of groups of questions, searching a question database, where the question database stores a plurality of groups of questions, wherein at least two questions of each of the plurality of groups of questions are presented in a non-consecutive manner to at least one other question of the plurality of groups of questions;
(c) accepting an answer to each question of the plurality of groups of questions and recording the answer;
(d) calculating output parameters that identify preferences of the user, where each of the output parameters is calculated by averaging answers to each question in each group of questions, wherein the output parameters comprise the user's ideation, risk, process, the sum of the user's ideation, risk and process, control, relationship, networking, input, flow, passion, output and energy; and
(e) displaying the output parameters in a graphical format on an electronic device, wherein each of the output parameters is depicted as its affinity to the two diverse poles.

A typical user takes from about four to about fifteen minutes to answer all fifty questions presented to the user.

In one embodiment, the two diverse poles are “builder” and “pioneer,” “self initiate” and “others initiate,” “concrete” and “visionary,” “converge” and “diverge,” “prudent” and “action,” “heart” and “head” and “self” and “people.”

In one embodiment, the graphical format is a single screen shot. In another embodiment, the graphical format is a single physical printed media.

Each output parameter is presented in a discrete scale representing a spectrum of the two diverse poles in a plurality of boxes. In one embodiment, the number of the output parameters is twelve.

In one embodiment, each of the plurality of boxes further represents three discrete positions or subsections, further refining the use of such boxes to represent a spectrum of representations within each box.

In one embodiment, the number of the plurality of boxes is six. In another embodiment, the number of the plurality of boxes is three.

In one embodiment, the output parameters comprise target answers superimposed on actual answers of the user on one display such that differences between the actual answers of the user can be discerned from the target answers. Such differences may be referred to as a Change Indicator Map (CIM) and may also be used to indicate differences between the present set of output parameters to a second set of output parameters of a second user. In addition to indicating the existence of differences between two sets of output parameters, a CIM also indicates the degree of such differences.

Accordingly, it is a primary object of the present invention to provide a system for determining orientations of an individual that is simple to conduct and whose result is easy to interpret.

It is another object of the present invention to provide a system for determining orientations whose result can be presented on one hardcopy sheet or one screen shot such that the presented material can be visually analyzed all on one sheet or screen or whose similarities can be easily matched to an ideal totem or whose differences can be easily discerned from an ideal totem.

It is a further object of the present invention to provide a system for determining orientations whose result is substantially immune to any efforts of users in providing untruthful answers by recognizing patterns of questions.

It is yet a further object of the present invention to provide a system for determining orientations where the answer choices of each question represent the degree of their affinity to two diverse poles, thereby providing users with sufficient but not overly complicated choices to select from.

It is yet a further object of the present invention to provide a system for determining orientations where strong orientations can be identified and ascertained as those closest to two diverse poles, eliminating the peril of selecting individuals without strong orientations when an ideal totem calls for such orientations.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram depicting the process in which a totem is built by starting from data collection.

FIG. 2 is a diagram depicting a means by which the answer to an output parameter is obtained.

FIG. 3 depicts a totem according to the present invention.

FIG. 4 depicts the representation of an individual's orientation in a totem.

FIG. 5 depicts a group of questions whose answers are used to result in a representation of an individual's orientation in terms of ideation.

FIG. 6 depicts a group of questions whose answers are used to result in a representation of an individual's orientation in terms of risk.

FIG. 7 depicts a group of questions whose answers are used to result in a representation of an individual's orientation in terms of process.

FIG. 8 depicts a group of questions whose answers are used to result in a representation of an individual's orientation in terms of control.

FIG. 9 depicts a group of questions whose answers are used to result in a representation of an individual's orientation in terms of relationship.

FIG. 10 depicts a group of questions whose answers are used to result in a representation of an individual's orientation in terms of network.

FIG. 11 depicts a group of questions whose answers are used to result in a representation of an individual's orientation in terms of input.

FIG. 12 depicts a group of questions whose answers are used to result in a representation of an individual's orientation in terms of flow.

FIG. 13 depicts a group of questions whose answers are used to result in a representation of an individual's orientation in terms of passion.

FIG. 14 depicts a group of questions whose answers are used to result in a representation of an individual's orientation in terms of output.

FIG. 15 depicts a group of questions whose answers are used to result in a representation of an individual's orientation in terms of energy.

FIG. 16 depicts an example totem of an incumbent as compared to an example ideal totem.

FIG. 17 depicts an example totem of an incumbent as compared to an example totem of a first candidate.

FIG. 18 depicts an example totem of a first candidate as compared to an example ideal totem.

FIG. 19 depicts an example totem of an incumbent as compared to an example totem of a second candidate.

FIG. 20 depicts an example totem of a second candidate as compared to an example ideal totem.

FIG. 21 depicts an example totem of an incumbent as compared to an example totem of a third candidate.

FIG. 22 depicts an example totem of a third candidate as compared to an example ideal totem.

FIG. 23 is a block diagram depicting one embodiment of the hardware for carrying out the present system.

### PARTS LIST

2—step in which questions are presented to individuals
4—step in which answers to questions are collected
6—step in which answers are mapped into subsections
8—step in which data points are resolved into 15 user attributes that are displayed on a totem
10—representation of an individual's orientation with respect to an output parameter
12—first box
14—second box
16—small miss
18—big miss
20—input device
22—output device
24—internet
26—web servers
28—central repository
30—monitoring device
32—“human” symbol
XB—extreme builder
B—builder
MB—mid builder
MP—mid pioneer
P—pioneer
XP—extreme pioneer

### PARTICULAR ADVANTAGES OF THE INVENTION

The present invention draws on research from all three aspects of mental functioning, i.e., cognitive, conative and affective while a prior art system and method such as Myers-Briggs Type Indicator (MBTI) which was originally derived from Carl Jung's work involving the existence of two dichotomous pairs of cognitive functions, i.e., the “rational” (judging) functions, e.g, thinking and feeling and the “irrational” (perceiving) functions, e.g., sensing and intuition. The result of the present invention is a totem that is easily viewed and interpreted as compared to more complex results such as those found in MBTI involving 16 personality types. The present invention measures a person's orientation rather than his or her capacity. With insight into orientations of individuals, teams can be assembled to optimize diversity and team functioning within the organization. Additionally, insight into one's own orientation and behavior patterns can help individuals work effectively with other team members, especially in innovation projects.

By presenting more than one question for each orientation, three or more answer choices for each question and answer choices that are disposed between two diverse poles, a user's orientation can be ascertained, especially if an answer falls on one of the two diverse poles, indicating a strong preference for such pole. In addition, in order to identify a suitable candidate for a position, it is a matter of matching the candidate's totem with an ideal totem drawn up for the position. In order to fill a position requiring an orientation complementary to an established totem, it is a matter of computationally or visually combining a candidate's totem with the established totem.

### DETAILED DESCRIPTION OF A PREFERRED EMBODIMENT

The term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

The Innovation Strengths Preference Indicator (ISPI) is an “indicator” of one's orientations or pre-dispositions for taking a specific approach to being innovative and looks at twelve unique “orientations” that affect how people prefer to approach innovation as well as working with others on a team to do so. The ISPI draws on research from all three aspects of mental functioning, i.e., how people think (cognitive), take action (conative), and meet their personal relational needs (affective), mapping all three brain functions in just one indicator.

FIG. 1 is a block diagram depicting the process in which a totem is built by starting from data collection. A set of fifty questions is first presented to a user or survey taker as in step 2. Each question includes at least three answer choices related to one of twelve orientations or characteristics. Upon receiving an answer to each of the fifty questions as in step 4, these answers are mapped in step 6 into 171 discrete positions in a totem. Each discrete position is a subsection, which is further described elsewhere herein. The set of fifty questions and their corresponding answers are divided into several groups, each corresponding to an orientation for a total of fifteen attributes or output parameters. Step 8 depicts a step where the twelve orientations including fifteen attributes are obtained and presented in a totemic format.

FIG. 2 is a diagram depicting a means by which the answer of an output parameter is obtained. In this example, a total of three questions (1, 2 and 3) are used to determine an attribute. The answers to questions 1, 2 and 3 are 4, 6 and 2, respectively. Each answer choice represents a position between two diverse poles or its affinity to one of the two diverse poles, which in this case are represented by “B” for builder and “P” for pioneer. The answer associated with the attribute is the arithmetic average of the answers of questions 1, 2 and 3, i.e., (4+6+2)/3=4. It is also possible to receive a non-whole number as an average. For instance, if the answers had been 4, 7 and 2, the average would have been (4+7+2)/3=4.33. In one embodiment as shown, answer choices range from 1-7 with 1 indicating an attribute most closely approximating “B” while 7 indicating an attribute most closely approximating “P.” In mapping answer choices to a 3-box output parameter, an answer in the range of from 1 to 3 is represented in the leftmost box and an answer in the range of from 5 to 7 is represented in the rightmost box. An answer of 4 is represented in the middle box. For a 6-box output parameter, an answer in the range of from 1 to 3 is represented in one of the leftmost boxes and an answer in the range of from 5 to 7 is represented in one of the rightmost boxes with the lowest number occupying the leftmost box and the highest number occupying the rightmost box. An answer of exactly 4.0 is represented either in the third box from the leftmost box or the third box from the rightmost box as there is not a box to represent the middle point. The decision to place the answer of 4.0 is made based on feedbacks from subsequent interviews with users. If the results from such interviews indicate that the placement has been accurate for a particular output parameter, the placement is left alone. Otherwise, the placement is changed.

FIG. 3 depicts a totem according to the present invention. The output parameters comprise user's ideation, risk, process, the sum of the user's ideation, risk and process, control, relationship, networking, input, flow, passion, output and energy. It shall be noted that the output parameters is presented in a discrete scale representing a spectrum bounded by two diverse poles in a plurality of boxes. Innovation Orientation theory asserts that people differ in their approaches to problem solving, decision making, creativity, working with others, etc. The ISPI is a measure of orientation, not capacity. It is an indicator of how one prefers to create and innovate and the type of innovation one likes to work on, not one's level of skill. Some individuals will prefer a “Builder” approach to innovation, while others will prefer a “Pioneer” approach. An individual's orientation is neither “good or bad” nor “right or wrong.” Groups require diversity of orientations to optimize their functioning. Each orientation has its own strengths and potential weaknesses. The purpose of the ISPI is to help one understand more clearly one's own and other people's Innovation Orientation (iO) and likely behavior patterns. The ISPI makes visible what is generally invisible to one and others.

This, in turn, helps to produce more effective individual and team performance that leads to more successful innovation efforts.

It shall also be noted that the totem is preferably presented on a single physical printed media, such as a piece of paper, etc. or on a single screen shot, such as a computer screen, where the printed media or screen shot is well within the peripheral field of view of an evaluator. The Applicant discovered that by presenting the totem in such a format, an evaluator can quickly glance at and gather sufficient information merely by a glance.

The totem is the sum of iO and Innovation Orientation Modifiers (iOM). The iO shows the position along the full innovation continuum a person prefers or is predisposed to work. In other words, this is one's “sweet spot” when it comes to being innovative and is comprised of four unique “orientations” as follows:

Ideation—One's approach to the generation of new ideas.
Risk—One's approach to taking risks.
Process—One's approach to establishing and following process.
Total iO—of one's Ideation, Risk and Process Orientation.

The iOM shows indicators that “modify” how one approaches developing innovative ideas, how one seeks information, makes decisions, finds energy to generate ideas, works with others, and one's preferred action mode. The iOM is made up of eight unique “orientations” as follows and each of the three of the iOMs, i.e., “Control,” “Relationship” and “Networking” orientations is further presented as two attributes (line items) to result in a total of fifteen attributes:

Control—One's approach to taking charge or allowing others to do so. “No” means that a person has no interest in controlling others. They are not all that interested in influencing the larger decision making process. “Flex” means that a person does not have strong preference on this characteristic. How the person responds depends on the situation. “Yes” means that a person prefers to be in control of projects when working with other people. The person tends to seek opportunities where he or she can oversee the work of others providing the necessary structure and decision making that will focus and guide the activities of others. The person seeks to influence the larger decision making process which is largely outside his or her direct control.

Relationship—One's approach to establishing personal relationships. With “I Initiate,” “No” means that a person does not prefer to reach out to get to know others. The person finds that too much self-disclosure is not comfortable for the person. The person tends to avoid conflict. “Flex” means that one does not have a strong preference on this characteristic; how one responds depends on the situation. “Yes” means that a person prefers to reach out to get to know others. It engages them both at head (intellect) and heart (emotion) levels. This is important for them in developing the necessary level of trust required for them to be most effective, especially on risky situations. With “Others Initiate,” “No” means that a person prefers to be left alone except perhaps for a few close working relationships. One does not necessarily dislike others; one just prefers to maintain their privacy. One is probably not comfortable disclosing personal information and does not expect it from others. “Flex” means that one does not have a strong preference on this characteristic; how one responds depends on the situation. “Yes” means that a person prefers to have others approach them to establish relationships. One signals this by showing a high degree of openness and friendliness to others.

Networking—One's approach to establishing and being part of networks. With “I Initiate,” “No” means that a person prefers to be more selective in who the person does or does not include. One tends to avoid meetings which one can find exhausting. If one builds networks at all, it will be with only those people who can affect the person's success on his/her job or assigned activities. “Flex” means that one does not have strong preference on this characteristic; how one responds depends on the situation. “Yes” means that a person prefers to have many contacts and acquaintances and one actively takes the lead to do this. One makes little distinction between work and the person's social life. One loves to be “in the know” in terms of what's going on in his/her organizations or elsewhere. One wants to avoid being blind-sided and one loves to give his/her input on many things. With “Others Initiate,” “No” means that a person prefers to be left alone to do his/her job or attend to his/her personal life. The person forms very few friendships. The person will tend to avoid being the center of attention. “Flex” means that one does not have a strong preference on this characteristic; how one responds depends on the situation. “Yes” means that a person prefers to be given the opportunity to attend social gatherings or meetings. One can feel snubbed if not invited.

One prefers to give input to decisions that might affect him/her or others. One does not want to be caught unaware of things that could affect his/her work or his/her life.

Input—One's approach to seeking information. “Concrete” means that when learning, processing or seeking new information, one's preference is to focus on “sensory” data or things that are concrete. Information that is measurable is perceived as more quantifiable to one and will increase the likelihood of one's retention. When able to process details of a situation, one will be better positioned to build incrementally toward a big picture. “Can Flex” means that when seeking or processing information, one sometimes prefer to process specific details and at other times prefer beginning with the “Big Picture.” Situational cues will influence how one proceeds. Because one “can flex,” one possesses an ability to understand how those around one are also processing information and in turn one may be influenced by these group norms. “Visionary” means that “tell one his/her destination and one will figure out how to get there later.” As a visionary, one values seeing the entire forest before looking at the individual trees as one prefers to see the Big Picture. One's imagination and visions of “what could be” serve greater purpose to one than finite details or specific pieces of information when designing systems. If one will be putting forth significant energy toward an effort, one's preference is to first understand or make sense of its prime objective.

Flow—One's approach to pursuing divergence or convergence. “Converge” means that as a person whose preference is to converge, one is someone who loves to plan, schedule things, hit all of one's timelines and cross them off one's list. One prefers to focus on a set of best practices or solutions that one feels will efficiently solve a problem. Once one has located a solution pathway that appears primed for success, one's preference is to steadily work toward a goal making it a reality without deviations or too many obstructions. “Can Flex” means that one possesses the ability to work toward a defined solution or keep one's options open depending on the circumstances. The situation one is in as well as the group one is engaged with will typically play a significant role in whether one converges or diverges when seeking solutions to problems. “Diverge” means that as someone who prefers to diverge when problem solving, one will formulate as many ideas as possible when seeking a solution. One gains satisfaction from discovering various ways to approach a problem as much as solving the problem. One will tend to focus on concepts and ideas more than timetables or schedules. One likes to keep one's options open.

Passion—One's approach to taking action. “Prudent” means that as someone who is prudent, one's preference is to take the necessary time to thoroughly process the meaning and ramifications of a chosen course of action. One will not want to proceed if one feels enough time has not been spent to thoroughly review all the plusses and minuses and their probabilities for any chosen solution. When making strategic decisions, one may be seen by others as frugal or overly cautious. “Depends” means that when making a decision, one possesses the ability to quickly spring into action or takes as much time as needed to process the ramifications of a chosen course of action. The surrounding environment and people involved will play a significant role in how quickly one takes action. “Action” means that one's preference is to spring into action quickly once an idea or solution has been generated. It is in one's nature to accept that mistakes are part of the learning process and one will change problem solving strategy as necessary while one creates. Since one is likely to progress to action quicker than others, at times one may become impatient if things are not moving fast enough for him/her. Some may view the person as one who acts on impulse.

Output—One's approach to making decisions. “Heart” means that when solving a problem or making a decision, it is one's preference to consider its impact on the people involved. That is not to say one is not concerned with effectiveness and functionality of outcomes; but as one decides on a solution to a problem, there will be consistent concern expressed for how well a solution can and will be utilized by others. “Can Flex” means that as a person who can make a decision with either one's head and/or heart, the situation one is in or group one is involved with will have the greatest impact on whether one's decision-making approach is more logic or people-based. One's ability to flex to logic or values makes one a favorable candidate for consultation on many topic areas. “Head” means that one prefers to look at matters rationally when making decisions. Facts and logic are the inputs one seeks when assessing how to develop a solution. The people who will benefit from a decision or solution do matter but they are thought of second. As a person who makes decisions with his/her head, one finds satisfaction in delivering solutions that are functional and efficient.

Energy—One's approach to seeking energy to solve problems. “Self” means one is able to recharge when one is alone. When involved in a long stretch of intense activity with others, one can become extremely fatigued and needs to be by oneself for a while so that one's internal state can settle before reengaging with other people. One tends to process one's ideas while alone, often overnight. One appreciates it when others give him/her the time to be alone to process one's ideas as it allows one to fully leverage one's capacity to deeply reflect on things. “Can Flex” means that as a person who can flex on how one energizes and reflects on ideas, one does not have a strong preference as to whether one wants to be alone or with others. At times, the situation will be the greatest determinant of one's preference. “People” means that one is energized by being around other people. This is most clearly seen after a long stretch of intense activity that leaves one exhausted. During times such as these, one finds that being with people involved in a new activity is very energizing and replenishing. One tends to process one's thoughts and ideas in conversation with others and enjoys working with others on projects.

In general, “Builders” are predisposed to work within a given paradigm in an effort to do things better and thereby improve the overall effectiveness and efficiency of the organization. “Pioneers” are predisposed to break out of the current paradigm in an effort to do things differently and create something entirely new. The spectrum shown in FIG. 3 ranges from “Extreme Builder” to “Extreme Pioneer.” One's answer or relative position is indicated by a “human” symbol 32. In summary and referring again to FIG. 3, the two diverse poles can be “builder” and “pioneer,” “self initiate” and “others initiate,” “concrete” and “visionary,” “converge” and “diverge,” “prudent” and “action,” “heart” and “head” and “self” and “people.”

FIG. 4 depicts the representation of an individual's orientation in a totem. Each of the plurality of boxes further represents three discrete positions or subsections. It shall be noted that an individual's orientation is further represented in one of the three discrete positions, i.e., 1, 2 or 3 within a box 10. Each of these subsections represents about ⅓ of a standard deviation. All boxes are labeled relative to the midpoint or center of an orientation. For clarity, dotted lines are used to show the divisions of a box into the three discrete positions although such lines may not be depicted in a totem so as not to complicate interpretation of a totem. In this example, the individual's orientation as shown in the first box 12 is viewed as having a strong affinity to “B” as it is disposed in discrete position “3” or closer to “B” and the first box 12 is closer to “B” than it is to “P.” The individual's orientation as shown in the second box 14, on the other hand is viewed as having a strong affinity to “P” as it is disposed in discrete position “3” or closer to “P” and the second box 14 is closer to “P” than it is to “B.” Referring to both FIGS. 2 and 2, if an answer is a non-whole number, it would be represented in one of the subsections within a box based on the size of its decimal portion ranging from a small number on the left side of the box to a large number on the right side of the box. The Applicants discovered that the manner in which one's totem is presented is critical in the amount of information gained by an evaluator while he or she evaluates a totem. In one preferred embodiment, six boxes are used to represent an orientation. In another embodiment, three boxes are used to represent an orientation.

FIGS. 5-15 depict groups of questions totaling fifty questions which are used to generate a totem for an individual. FIG. 5 depicts a group of questions whose answers are used to result in a representation of an individual's orientation in terms of ideation. The numbers in the left-most column represent the order in which the questions are presented to a user out of a total of fifty questions, i.e., 1st, 2nd, 3rd, 4th, 12th, 26th, 27th, 28th, 29th, 31st, 35th and 37th. These questions are meant to the gauge the user's orientation with respect to ideation. For instance:

“1 When faced with a problem, I generate lots and lots of new ideas or solutions.”
“2 When given the option, I prefer to work on problems that require incremental change or continuous improvement.”
“3 When given the chance, I choose to be immersed in frequent change.”
“4 I prefer to work on one problem at a time.”
“12 I prefer to work on one thing at a time until it's finished before moving on to the next project.”
“26 When faced with a problem, I only generate ideas or solutions that are relevant and/or useful.”
“27 When given the option, I prefer to work on problems that require the generation of real breakthrough or “out-of-the-box” ideas.”
“28 I prefer change to occur at a steady pace.”
“29 I prefer to work on several problems at one time.”
“31 I prefer to create new things as opposed to improving things that already exist.”
“35 I like to change my daily routine in the moment.”
“37 I prefer to work on several projects at one time jumping back and forth between them.

It shall be noted that questions are not presented in consecutive order from questions 1 through 50. The Applicant discovered that by obscuring the order of questions presented, a user may not discover a pattern to the questions and hence answer the questions in an untruthful manner. When asked in more than one way, a user who fabricates answers, tends to answer questions geared towards an orientation in an inconsistent manner. By taking an arithmetic average, the effects of untruthful answers can be lessened. As another example, FIG. 6 depicts a group of questions whose answers are used to result in a representation of an individual's orientation in terms of risk. The order in which the questions are presented to a user is 5^{th}, 6^{th}, 7^{th}, 8^{th}, 9^{th}, 10^{th}, 30^{th}, 32^{nd}, 33^{rd} and 34^{th}. FIGS. 7, 8, 9, 10, 11, 12, 13, 14 and 15 depict a group of questions whose answers are used to result in a representation of an individual's orientation in terms of process, control, relationship, network, input, flow, passion, output and energy, respectively. Therefore, at least two questions of each of the plurality of groups of questions is presented in a non-consecutive manner to at least one other question of the plurality of groups of questions.

In the ensuing Figures, there is provided an example depicting a process by which to identify the best person for succession planning or replacement for a job. In this process, a theoretical ideal totem is determined for the job, vetted and confirmed. First, interview questions are created for incumbent and potential candidates to create an ISPI for all involved. It shall be apparent from the ensuing example that the present system is a helpful tool to aid in the selection of a new candidate for a replacement position or to fill a position for an employee who is leaving. An ideal totem is created for the position based on the totem of the successful incumbent, interviews with coworkers and managers, and team discussion. The incumbent's totem and/or the ideal totem can be compared and evaluated against the totem of potential candidates. As an incumbent is leaving, a position needs to be filled. There are three candidates, i.e., Candidate #1 (first candidate), Candidate #2 (second candidate) and Candidate #3 (third position), for the position.

An ideal totem is determined by management with the understanding of the job to be vetted. An interview of the candidates is used to determine which traits are negotiable and which traits are non-negotiable. If possible, an interview is also conducted with the incumbent to determine which traits are negotiable and which traits are not. The ideal totem is compared with actual incumbent for the job. The candidates' orientations are then compared with the ideal totem for alignment. This is then followed by an interview with the incumbent person to help identify which ISPI orientations are negotiable and which are non-negotiable to help determine the best matching candidate. Key traits which produce success in the job being vetted are identified and an ideal totem is then produced. The totems of candidates are then compared to the ideal totem such that a candidate can be selected. If a perfect match of ISPI cannot be found in the existing candidates, it is possible to evaluate whether some traits are malleable or not. Upon matching totems, the skill base and values of the short listed candidate are then considered to ensure that the candidate will be a good fit.

FIG. 16 depicts an example totem of an incumbent as compared to an example ideal totem. A Change Indicator Map (CIM) is used to indicate the discrepancies of the incumbent's totem from the totem to which it is compared, which in this case, is the ideal totem for the position which the incumbent is currently having. It shall be noted that thirteen of the fifteen attributes are considered on target while there is one small miss 16 and a big miss 18. In one embodiment, the incumbent's totem is manually compared to the ideal totem. In another embodiment, the incumbent's totem is electronically compared with the ideal totem such that the CIM is automatically generated and superimposed upon the incumbent's totem to facilitate flagging of such discrepancies. In yet another embodiment, at least one criterion (e.g., no big misses) can be set such that only a totem which matches such criterion is considered. This is especially useful if a large number of totems are to be compared with an ideal totem. FIG. 17 depicts an example totem of an incumbent as compared to an example totem of a first candidate. The CIM indicates three big misses 18 as well as seven small misses 16. When compared to the ideal totem as shown in FIG. 18, the first candidate also shows significant misses including six big misses 18 and two small misses 16. A big miss, as used herein, represents a situation in which a survey taker's answer is more than three standard deviations away from a target or desired totemic position. Additionally, if an answer is disposed on an opposite side of a prominent behavioral-characteristic boundary, this would also be considered a big miss. A medium to small or small miss represents a situation in which a survey taker's answer is less than or equal to three standard deviations away from a target or desired totemic position. In one embodiment, the levels of misses are further color coded such that they may be more easily discerned. If desired, two totems may also be compared automatically by contrasting relative positions of each orientation. If a difference in relative positions exceeds a predetermined threshold, the difference is flagged.

FIG. 19 depicts an example totem of an incumbent as compared to an example totem of a second candidate. When the incumbent's totem is compared with the second candidate's totem, there are two big misses 18 and 9 small misses. FIG. 20 depicts an example totem of a second candidate as compared to an example ideal totem. Again, the second candidate's totem is significantly different than the ideal totem where there are five big misses and two small misses.

FIG. 21 depicts an example totem of an incumbent as compared to an example totem of a third candidate. When the incumbent's totem is compared with the third candidate's totem, there is only one big miss 18 and six small misses. FIG. 22 depicts an example totem of a third candidate as compared to an example ideal totem. Such comparison results in only three small misses 16 and no big misses 18. The third candidate therefore appears to be a more suitable candidate compared to the first and second candidates for the job to be filled as there are fewer big and small misses when compared to the ideal totem. In another embodiment not shown, in order to fill a position requiring an orientation complementary to an established totem, it is a matter of computationally or visually combining a candidate's totem with the established totem. For instance, if an established totem indicates that a current employee possesses only preferences as an extreme pioneer in ideation and risk, the candidate having strong preferences as an extreme builder in ideation and risk will be selected.

FIG. 23 is a block diagram depicting one embodiment of the hardware for carrying out the present system. The system includes an input/output device 20, 22, a monitoring device 30, at least one web server 26 and a central repository 28, where all of these hardware communicate via the internet 24. A web application is provided in the input/output and monitoring devices 20, 22, 30 accessible to a user or a manager. As will be appreciated by those skilled in the relevant art(s) after reading the description herein, in an aspect, the web application of devices 20, 22, 30 execute on one or more web servers 26 providing one or more websites which send out web pages in response to Hypertext Transfer Protocol (HTTP) or Hypertext Transfer Protocol Secured (HTTPS) requests from remote browsers. Thus, such web servers 26 are able to provide a graphical user interface (GUI) to users of the input/output/monitoring devices 20, 22, 30 or other devices utilizing the web application of the web servers 26 in the form of web pages. These web pages are sent to the input/output and monitoring devices 20, 22, 30. An input, output or monitoring devices 20, 22, 30 may be any one of these devices: desktop, laptop, mobile device, smart phone, personal digital assistant (PDA), electronic pad or like terminal devices where a GUI screens is capable of being displayed.

In preparing the present system for use, user interfaces, questions and answer choices are first stored in a database of the central repository 28 via the monitoring device 30. A user account for a user can be created prior to the user accessing the interface or at the time the user is accessing the interface. Upon logging into the user account, the user can then access a GUI which presents questions and answer choices associated with the questions via the input device 20. An input device 20 may include a keyboard and mouse, etc., via which the user can then select answers to the questions. A web server subsequently stores the received answers in the central repository 28 for the user account. In one embodiment, the central repository 28 is a memory device. In one embodiment, each web server contains a processor and a resident memory device or a logic element that is functionally connected to the processor. The GUI may be stored in this resident memory device or the memory device of the central repository 28.

At an opportune time or upon the submission of the answers, the answers are processed in one or more web servers such that the user's totemic data is calculated and again stored in the central repository 28. As previously disclosed, it is also possible to make a CIM available. If desired, a CIM can be calculated by comparing the user's orientations with a respective ideal totem and store the differences in the central repository 28. Similarly, upon receiving answers from the user, an interested party or a manager may access answers previously provided by the user by retrieving the answers from the central repository 28. Ideal totems may also be stored in the central repository 28 or locally at the monitoring device 30 such that it can be retrieved and presented side-by-side with the user's totem on the monitoring device 30. The manager may also choose to retrieve the CIM from the central repository 28 and superimpose it on the user's totem on the monitoring device 30. If desired, the user may also view his/her totem on the input/output device 20, 22 such that the user can better understand his/her own orientations. In another embodiment not shown, the input/output device 20, 22 may be eliminated and replaced simply with the monitoring device 30 or the monitoring device 30 may be eliminated and replaced simply with the input/output device 20, 22. As the present system operates via the internet 24, its use is not limited to a particular locale or time. If desired, the present system may also be run as a stand-alone application from a computer.

We claim:

1. A computer system for identifying preferences of a user and demonstrating said preferences in a graphical manner, said computer system comprising:
(a) a processor, said processor being a hardware component of said computer system; and
(b) a memory device in communication with said processor, said memory device storing a plurality of instructions that when executed by said processor, execute the steps of:
(i) providing an interface application, displayed on an electronic device, said interface having selectable options including at least an option to access data comprising a plurality of groups of questions, wherein each of said plurality of groups of questions comprises at least two questions whose answer choices are expressed as their affinity to two diverse poles;
(ii) in response to a user selection, via an electronic input device, to access said plurality of groups of questions, searching a question database, where said question database stores a plurality of groups of questions, wherein at least two questions of each of said plurality of groups of questions are presented in a non-consecutive manner to at least one other question of said plurality of groups of questions;
(iii) accepting an answer to each question of said plurality of groups of questions and recording said answer;
(iv) calculating output parameters that identify preferences of the user, where each of said output parameters is calculated by averaging answers to each question in each group of questions, wherein said output parameters comprise the user's ideation, risk, process, the sum of the user's ideation, risk and process, control, relationship, networking, input, flow, passion, output and energy; and
(v) displaying said output parameters in a graphical format on an electronic device, wherein each of said output parameters is depicted as its affinity to said two diverse poles.

2. The computer system of claim 1, wherein said two diverse poles are selected from a pole pair consisting of “builder” and “pioneer,” “self initiate” and “others initiate,” “concrete” and “visionary,” “converge” and “diverge,” “prudent” and “action,” “heart” and “head” and “self” and “people.”

3. The computer system of claim 1, wherein said graphical format is selected from a format consisting of a single screen shot and a single physical printed media.

4. The computer system of claim 1, wherein each of said output parameters is presented in a discrete scale representing a spectrum between said two diverse poles in a plurality of boxes.

5. The computer system of claim 4, wherein each of said plurality of boxes further represents three discrete positions.

6. The computer system of claim 4, wherein the number of said plurality of boxes is six.

7. The computer system of claim 4, wherein the number of said plurality of boxes is three.

8. The computer system of claim 1, wherein the number of said output parameters is twelve.

9. The computer system of claim 1, further comprising a Change Indicator Map (CIM) configured to indicate differences between said output parameters to a second set of output parameters of a second user.

10. The computer system of claim 9, wherein said differences further comprise the degree of differences between said output parameters and said second set of output parameters of a second user.

11. A computer system for identifying preferences of a user and demonstrating said preferences in a graphical manner, said computer system comprising:
(a) a processor, said processor being a hardware component of said computer system;
(b) a logic element in communication with said processor, configured to cause said processor to execute the steps of:
(i) providing an interface application, displayed on an electronic device, said interface having selectable options including at least an option to access data comprising a plurality of groups of questions, wherein each of said plurality of groups of questions comprises at least two questions whose answer choices are expressed as their affinity to two diverse poles;
(ii) in response to a user selection, via an electronic input device, to access said plurality of groups of questions, searching a question database, where said question database stores a plurality of groups of questions, wherein at least two questions of each of said plurality of groups of questions are presented in a non-consecutive manner to at least one other question of said plurality of groups of questions;
(iii) accepting an answer to each question of said plurality of groups of questions and recording said answer;
(iv) calculating output parameters that identify preferences of the user, where each of said output parameters is calculated by averaging answers to each question in each group of questions, wherein said output parameters comprise the user's ideation, risk, process, the sum of the user's ideation, risk and process, control, relationship, networking, input, flow, passion, output and energy; and
(v) displaying said output parameters in a graphical format on an electronic device, wherein each of said output parameters is depicted as its affinity to said two diverse poles.

12. The computer system of claim 11, wherein said two diverse poles are selected from a pole pair consisting of “builder” and “pioneer,” “self initiate” and “others initiate,” “concrete” and “visionary,” “converge” and “diverge,” “prudent” and “action,” “heart” and “head” and “self” and “people.”

13. The computer system of claim 11, wherein said graphical format is selected from a format consisting of a single screen shot and a single physical printed media.

14. The computer system of claim 11, further comprising a Change Indicator Map (CIM) configured to indicate differences between said output parameters to a second set of output parameters of a second user.

15. The computer system of claim 14, wherein said differences further comprise the degree of differences between said output parameters and said second set of output parameters of a second user.

16. A computer readable medium with program instructions tangibly stored thereon for identifying preferences of a user and demonstrating said preferences in a graphical manner, the program instructions comprising instructions for:
(a) providing an interface application, displayed on an electronic device, said interface having selectable options including at least an option to access data comprising a plurality of groups of questions, wherein each of said plurality of groups of questions comprises at least two questions whose answer choices are expressed as their affinity to two diverse poles;
(b) in response to a user selection, via an electronic input device, to access said plurality of groups of questions, searching a question database, where said question database stores a plurality of groups of questions, wherein at least two questions of each of said plurality of groups of questions are presented in a non-consecutive manner to at least one other question of said plurality of groups of questions;
(c) accepting an answer to each question of said plurality of groups of questions and recording said answer;
(d) calculating output parameters that identify preferences of the user, where each of said output parameters is calculated by averaging answers to each question in each group of questions, wherein said output parameters comprise the user's ideation, risk, process, the sum of the user's ideation, risk and process, control, relationship, networking, input, flow, passion, output and energy; and
(e) displaying said output parameters in a graphical format on an electronic device, wherein each of said output parameters is depicted as its affinity to said two diverse poles.

17. The computer readable medium of claim 16, wherein said two diverse poles are selected from a pole pair consisting of “builder” and “pioneer,” “self initiate” and “others initiate,” “concrete” and “visionary,” “converge” and “diverge,” “prudent” and “action,” “heart” and “head” and “self” and “people.”

18. The computer readable medium of claim 16, wherein said graphical format is selected from a format consisting of a single screen shot and a single physical printed media.

19. The computer readable medium of claim 16, further comprising a Change Indicator Map (CIM) configured to indicate differences between said output parameters to a second set of output parameters of a second user.

20. The computer readable medium of claim 19, wherein said differences further comprise the degree of differences between said output parameters and said second set of output parameters of a second user.
